(19) United States
(12) Patent Application Publication
(10) Pub. No.: US 2010/0254051 A1
(43) Pub. Date: Oct. 7, 2010

(54) Overvoltage Protection Circuits that Inhibit Electrostatic Discharge (ESD) and Electrical Overstress (EOS) Events from Damaging Integrated Circuit Devices

(76) Inventors: Chan-hee Jeon, Gyeonggi-do (KR); Min-Sun Hong, Seoul (KR); Tae-hoon Ha, Gyeonggi-do (KR); Han-gu Kim, Gyeonggi-do (KR)

Correspondence Address: MYERS BIGEL SIBLEY & SAJOVEC, PO BOX 37428, RALEIGH, NC, 27627, US

(21) Appl. No.: 12/502,310

(22) Filed: Jul. 14, 2009

(30) Foreign Application Priority Data
Apr. 6, 2009 (KR) 2009-29485

(51) Int. Cl. H02H 9/04

(52) U.S. Cl. 361/56

(57) ABSTRACT

An overvoltage protection circuit includes primary and secondary clamping circuits. The primary clamping circuit is configured to sink overvoltage current from a power supply voltage node (e.g., Vdd) to a reference voltage node (e.g., Vss) in response to an overvoltage condition at the power supply voltage node. The secondary clamping circuit, which is electrically coupled to an output of the primary clamping circuit, is configured to sink additional overvoltage current from the power supply voltage node to the reference node in response to detection of a overvoltage flag at the output of the primary clamping circuit. This overvoltage flag may be represented by a transition (e.g., low-to-high or high-to-low) of a signal generated at an output of the primary clamping circuit.

### REFERENCE TO PRIORITY APPLICATION

This application claims priority to Korean Patent Application No. 10-2009-0029485, filed Apr. 6, 2009, the contents of which are hereby incorporated herein by reference.

### FIELD OF THE INVENTION

The present inventive relates to integrated circuit devices and, more particularly, to overvoltage protection circuits.

### BACKGROUND

ESD and EOS events are different from each other in terms of an electrical transient pulse width. ESD typically refers to the sudden transfer of a finite amount of electric charge between two objects at different potentials. ESD spans from hundreds of pico-seconds (ps) to several micro-seconds (ts). EOS refers to an abnormal state, such as excessive current or excessive voltage, due to leakage current or voltage of equipment using a power supply. EOS spans from several nano-seconds (ns) to several milli-seconds (ms). If ESD or EOS occurs in a complementary metal oxide semiconductor (CMOS) product, a thin insulating layer, such as a gate oxide layer, may be damaged. Accordingly, a circuit for protecting the CMOS product from such ESD or EOS is required.

### SUMMARY

Embodiments of the invention include overvoltage protection circuits configured to protect integrated circuit devices from electrostatic discharge (ESD) and electrical overstress (EOS) events. Some of these overvoltage protection circuits include primary and secondary clamping circuits. The primary clamping circuit is configured to sink overvoltage current from a power supply voltage node (e.g., Vdd) to a reference voltage node (e.g., Vss) in response to an overvoltage condition at the power supply voltage node. The secondary clamping circuit, which is electrically coupled to an output of the primary clamping circuit, is configured to sink additional overvoltage current from the power supply voltage node to the reference node in response to detection of a overvoltage flag at the output of the primary clamping circuit. According to some embodiments of the invention, this overvoltage flag may be represented by a transition (e.g., low-to-high or high-to-low) of a signal generated at an output of the primary clamping circuit.

According to additional embodiments of the invention, the secondary clamping circuit may include an insulated gate transistor (e.g., FET, IGBT) having a gate terminal connected to the output of the primary clamping circuit and a first current carrying terminal electrically connected to the power supply voltage node. In some of these embodiments of the present invention, the insulated gate transistor has a second current carrying terminal electrically connected to the reference voltage node. In addition, the primary clamping circuit may include a delay circuit having an output electrically coupled to the secondary clamping circuit. According to some embodiments of the invention, the delay circuit may consist of an odd number of serially-connected inverters.

According to still further embodiments of the invention, the primary clamping circuit includes a node voltage maintaining circuit having an input node configured to sink current from the power supply voltage node when a voltage across the node voltage maintaining circuit exceeds a first threshold. This node voltage maintaining circuit may include at least one diode therein. In particular, the node voltage maintaining circuit may include a first diode having an anode electrically connected to an input of the delay circuit. In addition, the primary clamping circuit may also include a resistor, which is electrically coupled between the input node of the node voltage maintaining circuit and the power supply voltage node, and a capacitor, which has a first terminal electrically coupled to the input node of the node voltage maintaining circuit and a second terminal electrically coupled to the reference voltage node. According to the embodiments of the invention, the primary clamping circuit may include a node voltage maintaining circuit having an input node configured to sink current from the power supply voltage node when a voltage across the node voltage maintaining circuit exceeds a first threshold. A capacitor, resistor and delay circuit may also be provided. The capacitor has first and second terminals connected to the input node and an output node of the node voltage maintaining circuit, respectively, and the resistor has a first terminal connected to the second terminal of the capacitor and a second terminal connected to the reference voltage node. The delay circuit has an input electrically coupled to the second terminal of the capacitor and an output electrically connected to an input of the secondary clamping circuit.

### BRIEF DESCRIPTION OF THE DRAWINGS

Exemplary embodiments of the inventive concept will be more clearly understood from the following detailed description taken in conjunction with the accompanying drawings in which:

FIG. 1 is an electrical schematic of a circuit 100 for protecting a semiconductor circuit from electrostatic discharge (ESD) and electrical overstress (EOS), according to an embodiment of the invention;

FIG. 2 is a detailed circuit diagram of the circuit of FIG. 1;

FIGS. 3A-3B are graphs showing ESD and EOS pulses;

FIG. 4 is a graph showing simulation results obtained by applying an EOS pulse to the circuit of FIG. 2; and

FIGS. 5 through 7 are circuit diagrams illustrating modifications of the circuit of FIG. 1.

### DETAILED DESCRIPTION OF THE EMBODIMENTS

In order to fully understand operational advantages of the inventive concept and objects to be attained by embodiments of the inventive concept, the accompanying drawings illustrating exemplary embodiments of the inventive concept and details described in the accompanying drawings should be referred to.

The inventive concept will now be described more fully with reference to the accompanying drawings, in which exemplary embodiments of the inventive concept are shown. In the drawings, like reference numerals denote like elements.

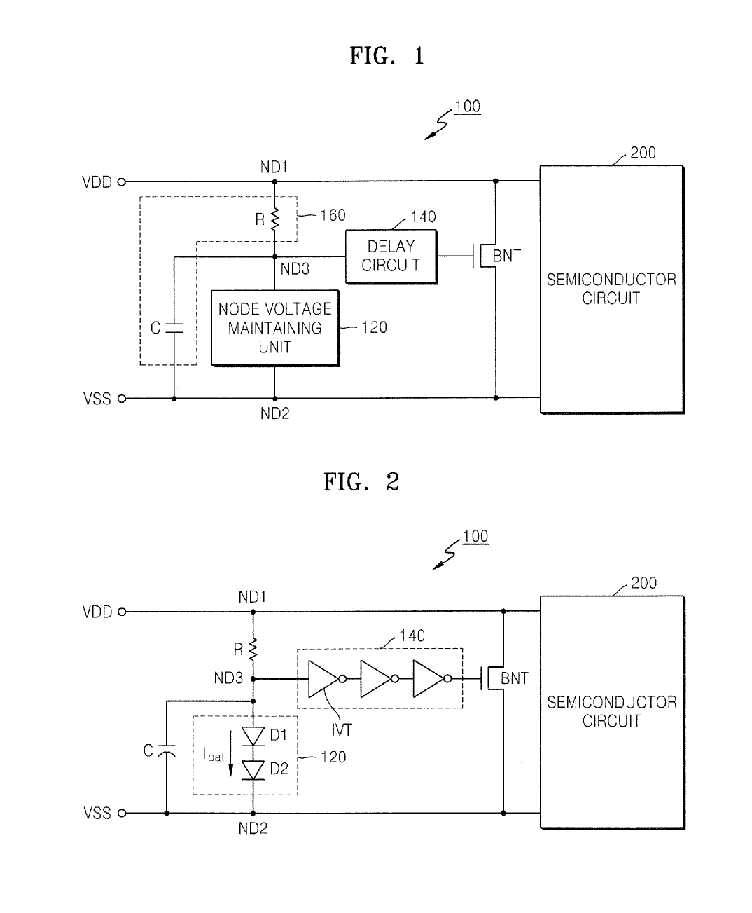

FIG. 1 is a circuit diagram of a circuit 100 for protecting a semiconductor circuit 200 from electrostatic discharge (ESD) and electrical overstress (EOS), according to an embodiment of the inventive concept. Referring to FIG. 1, the circuit 100 prevents excessive voltage or excessive current from being applied to the semiconductor circuit 200 that is connected between a first node ND1 and a second node ND2. A power voltage Vdd may be applied to the first node ND1, and a ground voltage VSS may be applied to the second node ND2. In order to prevent excessive voltage or excessive current to the semiconductor circuit 200, the circuit 100 includes a resistor R and a capacitor C, which are connected in series between the first node ND1 and the second node ND2, and a transistor BNT. The resistor R and/or the capacitor C may be a clamping circuit that maintains the level of the power voltage between the first node ND1 and the second node ND2.

The transistor BNT may be an n-type metal oxide semiconductor (NMOS) transistor. In particular, the transistor BNT may be a gate-coupled NMOS (GCNMOS) transistor from which a silicide blocking layer (SBL) is removed, and especially may be an insulated-gate bipolar transistor (IGBT) having a relatively large size.

The transistor BNT is gated in response to the voltage of a third node ND3 that is connected to a gate of the transistor BNT. The circuit 100 may further include a delay circuit 140 that is connected between the third node ND3 and the gate of the transistor BNT, so that the transistor BNT can be gated in response to the voltage of the third node ND3 which is delayed by a first delay time.

FIG. 2 is a detailed circuit diagram of the circuit 100 of FIG. 1. In FIG. 2, the delay circuit 140 may include a plurality of inverters IVT that are connected in series as shown in FIG. 2. In particular, the delay circuit 140 includes three inverters IVT in FIG. 2. Since the circuit 100 includes an odd number of inverters IVT that are connected between the third node ND3 and the gate of the transistor BNT, the transistor BNT is gated by the inverted version of the voltage of the third node ND3.

Referring to FIG. 2, if a power voltage Vdd is the same as an operating voltage (e.g., 1.2 V), of the semiconductor circuit 200, the voltage of the third node ND3 can be maintained at a logic high level “H”. Accordingly, since a voltage having a logic low level “L” is applied to the gate of the transistor BNT, the transistor BNT is maintained in an off state. Hence, the power voltage Vdd is normally applied to the semiconductor circuit 200. If a power voltage VDD is higher than 5 V, for example, exceeding the operating voltage (e.g., 1.2 V), of the semiconductor circuit 200, the capacitor C may be instantly turned on due to coupling, and the voltage of the third node ND3 may be a logic 0 voltage relative to VDD. Accordingly, a voltage having a logic high level “H” is applied to the gate of the transistor BNT, so that the transistor BNT is turned on. As the transistor BNT is turned on, current begins to flow from the first node ND1 to the second node ND2 through the transistor BNT. As a result, excessive voltage or excessive current can be prevented from being applied to the semiconductor circuit 200. However, if an RC time constant, which is obtained from multiplying the resistance of the resistor R by the capacitance of the capacitor C, elapses, the capacitor C is completely charged and the voltage of the third node ND3 may have a logic high level “H” again. Accordingly, the transistor BNT is turned off again. That is, the transistor BNT is turned on only during the RC time constant.

The RC time constant corresponding to a period of time for which the GCNMOS transistor of the circuit 100 is turned on may be adaptively determined according to the length of an ESD pulse. That is, if the RC time constant is determined to correspond to the length of the ESD pulse, the transistor BNT can be sufficiently maintained in an on state while the ESD pulse is applied.

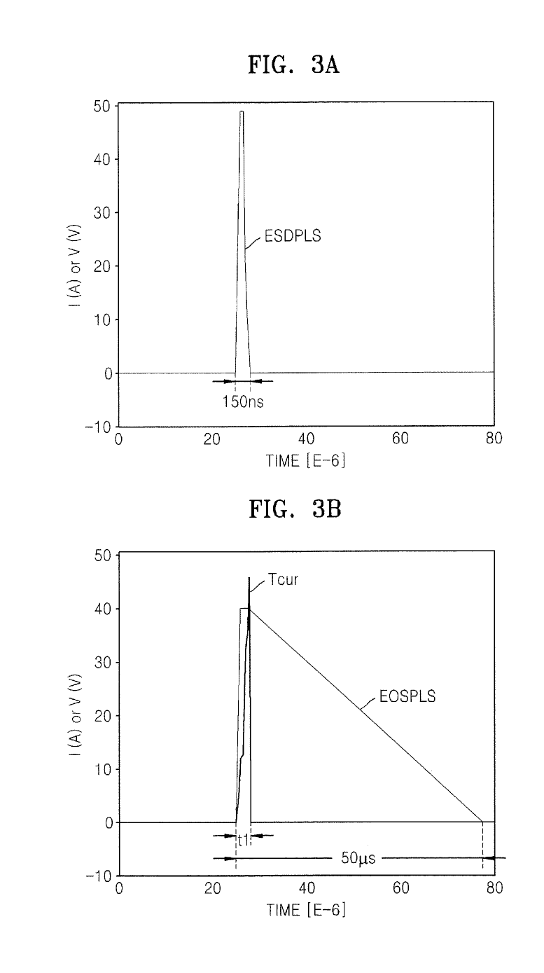

FIG. 3 is graphs showing ESD and EOS pulses. Referring to FIG. 3, the duration of an ESD pulse is about 50 ns as shown in FIG. 3(a) whereas the duration of an EOS pulse is about 50 μs as shown in FIG. 3(b). Assuming that the EOS pulse, a duration of which is longer than that of the ESD pulse, is applied, even though a large amount of current flows from the node ND1 to the second node ND2 from the beginning, if a time constant t1 determined to correspond to the length of the ESD pulse elapses while the EOS pulse is applied, the transistor BNT is turned off. Accordingly, residual current is left behind in the transistor BNT, and acts as stress to the transistor BNT, thereby causing the transistor BNT to enter a parasitic bipolar mode, damaging the transistor BNT, and leading to a transistor failure. In particular, if the transistor BNT is a GCNMOS transistor with no SBL, the transistor BNT enters a snapback mode due to a parasitic bipolar action, thereby leading to an early transistor failure. In order to prevent these problems, the time constant t1 may be increased so as to sufficiently maintain the transistor BNT in an on state. However, in this case, a layout area is increased.

Accordingly, the circuit 100 includes a node voltage maintaining unit 120 as shown in FIG. 1 which maintains the voltage of the third node ND3 at a logic low level “L” for a period of time corresponding to the length of the EOS pulse. That is, the circuit 100 includes the node voltage maintaining unit 120 of FIG. 1 in order to sufficiently maintain the transistor BNT in an on state.

Preferably, the node voltage maintaining unit 120 may include one or more diodes D1 and D2 that are connected in series between the second node ND2 and the third node ND3 as shown in FIG. 2. The diodes D1 and D2 may be turned on when the voltage of the third node ND3 is higher than a reference voltage. For example, if the two diodes D1 and D2 are connected in series between the second node ND2 and the third node ND3 as shown in FIG. 2, when the voltage of the third node ND3 is higher than 1.4 V, the diodes D1 and D2 are turned on. As a result, a current path from the third node ND3 to the second node ND2 through the diodes D1 and D2 is formed.

If the ESD pulse is applied, the voltage of the third node ND3 is not higher than the reference voltage that enables the diodes D1 and D2 to be turned on due to the short duration of the ESD pulse as described above. That is, if the ESD pulse is applied, only a current path through the resistor R and the capacitor C is formed. However, if the EOS pulse is applied, even after the RC time constant elapses, the voltage of the third node ND3 is still higher than the reference voltage due to the long duration of the EOS pulse. Accordingly, the diodes D1 and D2 are turned on, and the voltage of the third node ND3 can be maintained at a logic low level “L” due to a culTent path Ipat formed from the third node ND3 to the second node ND2 through the diodes D1 and D2.

The number of diodes connected in series between the second ND2 and the third node ND3 corresponds to the magnitude of an operating voltage of the semiconductor circuit 200, that is, a power voltage VDD. The power voltage VDD may be normally applied so as not to turn on the diodes. For example, if the power voltage VDD is 1.2 V, two diodes may be connected as shown in FIG. 2. If the power voltage VDD is 3.3 V, 5 diodes may be connected.

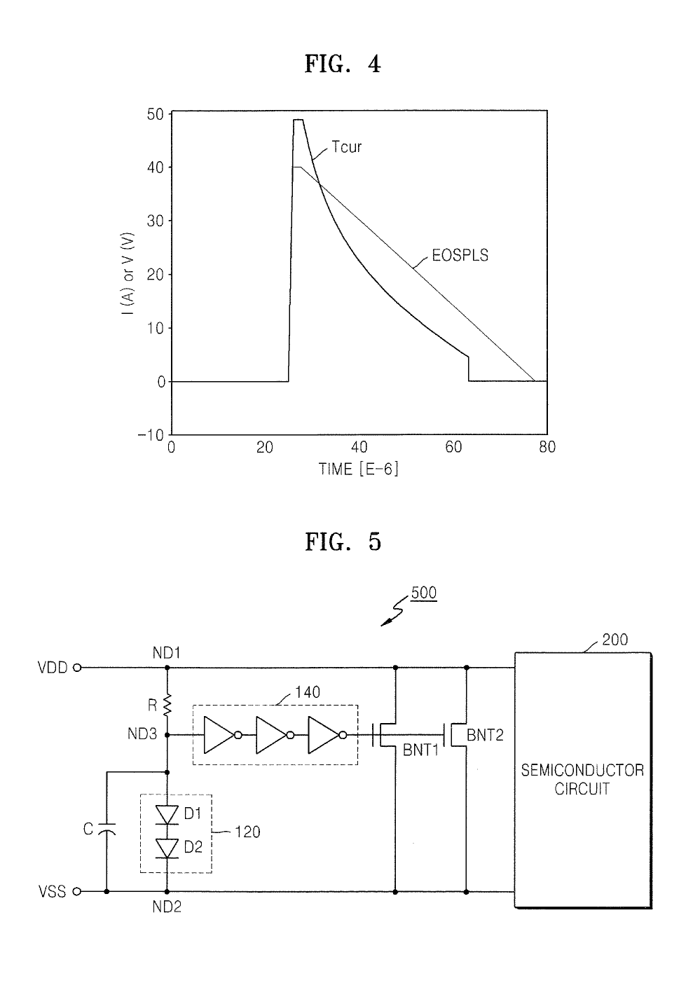

FIG. 4 is a graph showing simulation results obtained by applying an EOS pulse to the circuit 100 of FIG. 2. Referring to FIGS. 2 and 4, if the EOS pulse is applied, the voltage of the third node ND3 is maintained at a logic low level “L” due to the current path Ipat formed from the third node ND3 to the second node ND2 through the diodes D1 and D2, and a current Tcur flows through the transistor BNT for a period of time corresponding to the duration of the EOS pulse. Since the voltage of the third node ND3 is maintained for the period of time adapted to the EOS pulse without adjusting the RC time constant, the transistor BNT can be sufficiently maintained in an on state. Accordingly, a transistor failure and damage to the transistor BNT due to a parasitic bipolar action when the transistor BNT is turned off while the EOS pulse is applied can be prevented.

FIG. 5 is a circuit diagram illustrating a modification of the circuit 100 of FIG. 1. Referring to FIG. 5, two transistors BNT1 and BNT2 are connected in parallel between the first node ND1 and the second node ND2. Each of the transistors BNT1 and BNT2 is a GCNMOS transistor from which SBL is removed, and may be an IGBT having a relatively small size.

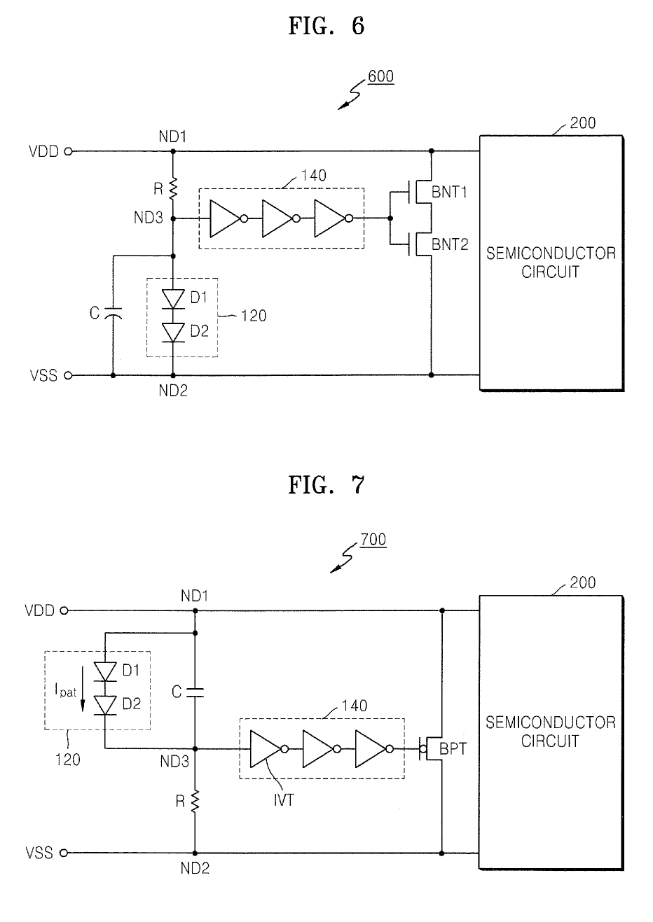

FIG. 6 is a circuit diagram illustrating another modification of the circuit 100 of FIG. 1. Referring to FIG. 6, the transistors BNT1 and BNT2 may be connected in series between the first node ND1 and the second node ND2. Each of the transistors BNT1 and BNT2 may be a GCNMOS transistor from which SBL is removed, and may be an IGBT having a relatively small size. Accordingly, circuits 500 and 600 for protecting the semiconductor circuit 200 of from ESD and EOS of FIGS. 5 and 6 can protect the semiconductor circuit 200 from ESD and EOS by arranging a number of transistors in various ways. However, the inventive concept is not limited thereto, and a p-type metal oxide semiconductor (PMOS) transistor may be further disposed as shown in FIG. 7.

FIG. 7 is a circuit diagram illustrating another modification of the circuit 100 of FIG. 1. Referring to FIG. 7, a PMOS transistor BPT is connected between the first node ND1 and the second node ND2, different from FIG. 2. The capacitor C is connected between the first node ND1 and the third node ND3, and the resistor R is connected between the second node ND2 and the third node ND3. The delay unit 140 includes an odd number of inverters IVT to gate the PMOS transistor BPT. If a power voltage VDD is the same as an operating voltage, e.g., 1.2 V, of the semiconductor circuit 200, the voltage of the third node ND3 becomes a logic low level “L”. Accordingly, a voltage having a logic high level “H” is applied to the gate of the transistor BNT, so that the PMOS transistor BPT is maintained in an off state. Hence, the power voltage VDD is normally applied to the semiconductor circuit 200.

If a power voltage VDD is higher 5 V exceeding the operating voltage (e.g., 1.2 V), of the semiconductor circuit 200 is applied, the capacitor C is instantly turned on due to coupling, and the voltage of the third node ND3 can become the same as the voltage of the first node ND1. Accordingly, a voltage having a logic low level “L” is applied to the gate of the transistor BPT, so that the transistor BPT is turned on.

As the transistor BNT is turned on, current begins to flow from the first node ND1 to the second node ND2 through the transistor BNT. As a result, excessive voltage or excessive current can be prevented from being applied to the semiconductor circuit 200.

If an ESD pulse is applied to a circuit 700 for protecting the semiconductor circuit 200 from ESD and EOS of FIG. 7 including the node voltage maintaining unit 120 that includes the diodes D1 and D2, since a voltage difference between the third node ND3 and the first node ND1 is not higher than a voltage that enables the diodes D1 and D2 to be turned on due to the short duration of the ESD pulse, only a current path through the resistor R and the capacitor C is formed.

If an EOS pulse is applied, even after the RC time constant elapses, since a voltage difference between the third node ND3 and the first node ND1 is higher than the voltage that enables the diodes D1 and D2 to be turned on due to the long duration of the EOS pulse, a current path Ipat is formed from the third node ND3 to the second node ND2 through the diodes D1 and D2 that are turned on, thereby making it possible to maintain the voltage of the third node ND3 at a logic high level “H”.

The number of diodes that are forwardly connected in series between the first node ND1 and the third node ND3 corresponds to the magnitude of an operating voltage of the semiconductor circuit 200, that is, a power voltage VDD. The power voltage VDD may be normally applied so as not to turn on the diodes. For example, if the power voltage VDD is 1.2 V , two diodes may be connected as shown in FIG. 2, and if the power voltage VDD is 3.3 V, five diodes may be connected.

If the EOS pulse is applied, the voltage of the third node ND3 is maintained at a logic high level “H” and a current Tcur flows through the transistor BPT for a period of time corresponding to the duration of the EOS pulse, due to the current path Ipat formed from the first node ND1 to the third node ND3 through the diodes.

Since the voltage of the third node ND3 is maintained for the period of time adapted to the EOS pulse without adjusting the RC time constant, the PMOS transistor BPT can be sufficiently maintained in an on state. Accordingly, a transistor failure and damage to the PMOS transistor BPT due to a parasitic bipolar action when the PMOS transistor BPT is turned off while the EOS pulse is applied can be prevented. Thus, as described hereinabove, embodiments of the invention include overvoltage protection circuits (e.g., 100, 500, 600, 700) configured to protect integrated circuit devices from electrostatic discharge (ESD) and electrical overstress (EOS) events. Some of these overvoltage protection circuits include primary and secondary clamping circuits. The primary clamping circuit is configured to sink overvoltage current from a power supply voltage node (e.g., Vdd) to a reference voltage node (e.g., Vss) in response to an overvoltage condition at the power supply voltage node. The secondary clamping circuit, which is electrically coupled to an output of the primary clamping circuit, is configured to sink additional overvoltage current from the power supply voltage node to the reference node in response to detection of a overvoltage flag at the output of the primary clamping circuit. According to some embodiments of the invention, this overvoltage flag may be represented by a transition (e.g., low-to-high or high-to-low) of a signal generated at an output of the primary clamping circuit (i.e., output of delay circuit 140).

According to additional embodiments of the invention, the secondary clamping circuit may include an insulated gate transistor (e.g., FET, IGBT) having a gate terminal connected to the output of the primary clamping circuit and a first current carrying terminal electrically connected to the power supply voltage node. In some of these embodiments of the present invention, the insulated gate transistor (e.g., BNT, BPT) has a second current carrying terminal electrically connected to the reference voltage node. In addition, the primary clamping circuit may include a delay circuit 140 having an output electrically coupled to the secondary clamping circuit. According to some embodiments of the invention, the delay circuit may consist of an odd number of serially-connected inverters (IVT). These inverters generate the overvoltage flag when a duration of an overvoltage event exceeds a threshold duration.

According to still further embodiments of the invention, the primary clamping circuit includes a node voltage maintaining circuit 120 having an input node (e.g., ND3) configured to sink current from the power supply voltage node when a voltage across the node voltage maintaining circuit 130 exceeds a first threshold. This node voltage maintaining circuit 120 may include at least one diode (e.g., D1, D2, . . . ) therein. In particular, the node voltage maintaining circuit 120 may include a first diode D1 having an anode electrically connected to an input of the delay circuit 140. In addition, the primary clamping circuit 120 may also include a resistor R, which is electrically coupled between the input node of the node voltage maintaining circuit 120 and the power supply voltage node, and a capacitor C, which has a first terminal electrically coupled to the input node of the node voltage maintaining circuit 120 and a second terminal electrically coupled to the reference voltage node. According to the embodiment of FIG. 7, the primary clamping circuit may include a node voltage maintaining circuit 120 having an input node configured to sink current from the power supply voltage node when a voltage across the node voltage maintaining circuit exceeds a first threshold. A capacitor C, resistor R and delay circuit 140 may also be provided. The capacitor has first and second terminals connected to the input node and an output node of the node voltage maintaining circuit 120, respectively, and the resistor has a first terminal connected to the second terminal of the capacitor at node ND3 and a second terminal connected to the reference voltage node VSS. The delay circuit has an input electrically coupled to the second terminal of the capacitor at node ND3 and an output electrically connected to an input of the secondary clamping circuit (shown as transistor BPT).

While the inventive concept has been particularly shown and described with reference to exemplary embodiments thereof using specific terms, the embodiments and terms have been used to explain the inventive concept and should not be construed as limiting the scope of the inventive concept defined by the claims. The preferred embodiments should be considered in a descriptive sense only and not for purposes of limitation. Therefore, the scope of the inventive concept is defined not by the detailed description but by the appended claims, and all differences within the scope will be construed as being included in the inventive concept.

What is claimed is:

1. An overvoltage protection circuit, comprising:
a primary clamping circuit configured to sink overvoltage current from a power supply voltage node to a reference voltage node in response to an overvoltage condition at the power supply voltage node; and
a secondary clamping circuit electrically coupled to an output of said primary clamping circuit, said secondary clamping circuit configured to sink additional overvoltage current from the power supply voltage node to the reference node in response to detection of a overvoltage flag at the output of said primary clamping circuit.

2. The overvoltage protection circuit of claim 1, wherein said secondary clamping circuit comprises an insulated gate transistor having a gate terminal connected to the output of said primary clamping circuit and a first current carrying terminal electrically connected to the power supply voltage node.

3. The overvoltage protection circuit of claim 2, wherein the insulated gate transistor has a second current carrying terminal electrically connected to the reference voltage node.

4. The overvoltage protection circuit of claim 1, wherein said primary clamping circuit comprises a delay circuit having an output electrically coupled to said secondary clamping circuit.

5. The overvoltage protection circuit of claim 4, wherein the delay circuit consists of an odd number of serially-connected inverters.

6. The overvoltage protection circuit of claim 1, wherein said primary clamping circuit comprises a node voltage maintaining circuit having an input node configured to sink current from the power supply voltage node when a voltage across the node voltage maintaining circuit exceeds a first threshold.

7. The overvoltage protection circuit of claim 6, wherein the node voltage maintaining circuit comprises at least one diode.

8. The overvoltage protection circuit of claim 4, wherein said primary clamping circuit comprises a node voltage maintaining circuit having an input node configured to sink current from the power supply voltage node when a voltage across the node voltage maintaining circuit exceeds a first threshold; and wherein the node voltage maintaining circuit comprises a first diode having an anode electrically connected to an input of the delay circuit.

9. The overvoltage protection circuit of claim 6, wherein said primary clamping circuit further comprises:
a resistor electrically coupled between the input node of the node voltage maintaining circuit and the power supply voltage node; and
a capacitor having a first terminal electrically coupled to the input node of the node voltage maintaining circuit and a second terminal electrically coupled to the reference voltage node.

10. The overvoltage protection circuit of claim 1, wherein said primary clamping circuit comprises:
a node voltage maintaining circuit having an input node configured to sink current from the power supply voltage node when a voltage across the node voltage maintaining circuit exceeds a first threshold;
a capacitor having first and second terminals connected to the input node and an output node of said node voltage maintaining circuit, respectively;
a resistor having a first terminal connected to the second terminal of said capacitor and a second terminal connected to the reference voltage node; and
a delay circuit having an input electrically coupled to the second terminal of said capacitor and an output electrically connected to an input of said secondary clamping circuit.

11. A circuit for protecting a semiconductor circuit, which is connected between a first node to which a power voltage is applied and a second node to which a ground voltage is applied, from electrostatic discharge (ESD) and electrical overstress (EOS) by preventing excessive voltage from being applied to the semiconductor circuit, the circuit comprising:
a clamping circuit connected between the first node and the second node and maintaining the level of the power voltage;
a transistor connected in parallel to the clamping circuit, and adapted to be gated in response to a voltage of a third node to form a current path from the first node to the second node and to prevent excessive voltage or excessive current corresponding to an ESD pulse and an EOS pulse from being applied to the semiconductor circuit; and
a node voltage maintaining unit maintaining the voltage of the third node so as for the transistor to form the current path for a period of time corresponding to a duration of the EOS pulse.

12. The circuit of claim 11, wherein the transistor is an n-type metal oxide semiconductor (NMOS) transistor having a channel width large enough to discharge the ESD pulse or the EOS pulse, wherein the clamping circuit comprises:
a resistor having one end connected to the first node and the other end connected to the third node; and
a capacitor having one end connected to the other end of the resistor and the other end connected to the second node.

13. The circuit of claim 12, wherein a time constant of the clamping circuit is determined to correspond to a duration of the ESD pulse.

14. The circuit of claim 12, further comprising an odd number of inverters connected in series between the third node and a gate of the transistor.

15. The circuit of claim 11, wherein the node voltage maintaining unit comprises one or more diodes connected in series from the third node to the second node.

16. The circuit of claim 15, wherein the number of the diodes of the node voltage maintaining unit corresponds to the magnitude of the power voltage.

17. The circuit of claim 11, wherein a plurality of transistors, which are connected in series or in parallel between the first node and the second node, are used.

18. The circuit of claim 11, further comprising a delay circuit connected between the third node and a gate of the transistor.

19. The circuit of claim 11, wherein the transistor is a p-type metal oxide semiconductor (PMOS) transistor having a channel width large enough to discharge the ESD pulse or the EOS pulse, wherein the clamping circuit comprises:
a capacitor having one end connected to the first node and the other end connected to the third node; and
a resistor having one end connected to the other end of the capacitor and the other end connected to the second node.

20. The circuit of claim 19, wherein the node voltage maintaining unit comprises one or more diodes that are forwardly connected in series between the first node and the third node.
